(19) United States
(12) Patent Application Publication
(10) Pub. No.: US 2018/0012203 A1
(43) Pub. Date: Jan. 11, 2018

(54) ELECTRONIC PAYMENT SYSTEM WITH OPTION TO ACCEPT OR REJECT A PROFFERED PAYMENT

(71) Applicant: Edward Hall, Winter Garden, FL (US)

(72) Inventor: Edward Hall, Winter Garden, FL (US)

(21) Appl. No.: 15/202,752

(22) Filed: Jul. 6, 2016

(51) Int. Cl. G06Q 20/10; G06Q 20/14

(52) U.S. Cl. CPC G06Q 20/102; G06Q 20/14

(57) ABSTRACT

A system and method for selective processing of electronic payments such as rent, utility bill payments or debtor settlement payments is disclosed. Payer tenders an electronic payment through a web-based user interface and a notice is transmitted to Payee that funds are available for transfer if Payee chooses to accept the payment. Payee has the opportunity to manually review the details of the incoming payment and can choose to accept the payment, in which case, funds are transferred to Payee, or reject it, in which case the transfer of the funds is cancelled and no payment is made to the Payee. The Payee may also define a set of rules or conditions (including lower acceptance amount or partial conditions in case of negotiations), which would govern the automatic acceptance processing of the transaction.

### FIELD OF THE INVENTION

This invention relates to the field of electronic payment processing through the Internet or network-based interfaces, mobile apps and other electronic communications means used by the participants and a payment clearing service. More specifically, it relates to an electronic payment system that allows the recipient to accept or reject the proffered electronic payment and attach various conditions as part of the acceptance or rejection process step.

### BACKGROUND OF THE INVENTION

Internet-based online payment for goods or services, or payments of a variety of obligations, is common at the present time. For example, an individual may go to a website maintained by the USPTO, fill in an electronic form, select a payment method, such as a credit card or debit card, enter the appropriate authorizing information, and click “Submit.” Funds are then transferred, an electronic receipt is displayed, and a receipt is transmitted to the customer. Convenience to the customer and provider is manifest: an immediate payment and receipt are generated without the need for the customer to travel to a service center maintained by the USPTO; moreover, these transactions may be processed 24-hours-a-day, 7 days-a-week. The online commerce and Internet-based mobile apps work in a similar manner, allowing an individual to submit payment to a vendor or service provider electronically, via Internet.

In the above example, the immediate transfer of money creates an obligation on the part of the USPTO to perform a specific act, whether it is to process a trademark application or to review a patent application. It is this reliable and secure transfer of funds that is the foundation of electronic commerce and the orderly exchange of goods and services.

The property management industry, made up of building owners that rent residential or commercial real estate to Payers, can also benefit from the convenience and accuracy of a web-based system for payment and collection of rent. While some Payees collect rent directly from Payers, many large volume building owners depend upon property manager agents to administer the collection of rents and eviction of non-paying tenants, among other duties. Similarly, utility service providers such as water, electricity and waste collection can benefit from the electronic presentation of bills and the ensuing accelerated payment of outstanding bills.

One characteristic of the Payee-Payer relationship that separates the property management industry from many others is that acceptance by the Payee of a Payer's rent payment may convey substantive rights to a Payer with respect to the leased premises. The relationship is governed by state laws. In some states, acceptance of even a small partial payment engenders a cure period wherein the Payer has a set number of days to make the balance of the factually overdue rent payment, automatically waives any penalties and reinstates the Payer relationship to ‘in good standing’. Residential Payee-Payer statutes in many states, drafted to protect Payers from evictions, offer a variety of Payer rights stemming from the making of part payment for current or overdue past rent.

Utility service providers face similar issues when dealing with customers whose payments are overdue and have been informed that their service will be cut-off unless full payment including late fees or other charges are received by a set time and date.

As electronic payments have become pervasive and almost universal, there has arisen a need for an alternate payment methodology and system that recognizes the needs of other businesses and entities who wish to participate in electronic commerce, but whose business methodology or policies or governmental regulations restrict this ability. Because of the possibility of the creation or changes in the substantive Payer rights upon the Payee's acceptance of a payment, in the examples cited above and numerous others, the Payee may incur certain obligations on account of accepting funds from a Payer. In such simple-acceptance-based systems, the Payee's rights are not well served by a web-based payment system that automatically transfers the tendered funds by the Payee. Thus, there is a need for a system where the Payee or his agent has the ability to reject a payment if the amount is incorrect, set up partial acceptance or partial rejection, subject to some conditions, or make sure that Payee's acceptance would not automatically establish rights adverse to the Payee's interests.

Conventional payment systems in which the Payer entrusts a payment processing service to automatically deliver their payment to the Payee can easily create adverse and inadvertent obligations on the part of the Payee who may have unknowingly received a payment without having had the opportunity to decide if they want to, in fact, accept the payment, and without the possibility of attaching any conditions to the acceptance.

The alternative payment method described in this application is typically described to potential users as the ‘accept or reject’ method. This name has become so entwined with this method that the applicant filed an application to register the ‘Accept or Reject’ trademark and has since received approval of its registration since these words refer to the method and the opportunity for use the applicant's system.

The applicant's system and method are particularly useful to businesses to companies in markets which require or can use the ‘accept or reject’ methodology and system. In a recent example, a very large title and escrow company sought out the applicant to license the ‘accept or reject’ payment method to enable its customers, such as, for example, home purchasers, to make initial escrow deposits as part of their purchase transaction. The company had previously attempted to create its own escrow deposit system which failed to meet company and state regulations which require the company to be in possession of a signed ‘escrow’ agreement before accepting funds into its trust account and instead turned to the applicant since in its words “we've looked everywhere, and you guys are the only game in town”.

The above statement illustrates an important features of and a fact about the present invention: the methodology and technology that is the subject of this application is neither intuitive nor easily re-created, since if it were, there would be numerous other companies offering this online payment methodology. However, in the applicant's twelve years of experience in the payment processing industry, there were encountered no systems or methodologies that offer a similar payment method and system as described below.

These and other beneficial features and advantages of the present invention are disclosed in detail hereinafter with reference to the accompanying drawings and descriptive matter in each embodiment of the invention.

### SUMMARY OF THE PRESENT INVENTION

The present invention is a network or web-based payment processing system and methodology that is particularly useful for Payees whose rights or obligations might be adversely affected if a Payer's payment is automatically deposited to their account and then is automatically considered accepted, without any possibility of attaching conditions to acceptance. The Payer logs into the system and makes a payment in much the same way he would pay other bills online. Simultaneously, the Payee is sent an email message that a payment is being offered. The Payee or his agent logs in at a convenient time and reviews the proffered payment. If he or she elects to accept the payment, the transfer of funds is then initiated in much the same way as a conventional electronic payment is made and the funds are deposited to the Payee's account, and a notice of acceptance is transmitted to the Payer. Any deficient payments may be rejected with a mouse click, and the manager may add a comment explaining the rejection. When a payment is rejected, a message advising of the rejection is transmitted to the Payer.

One feature of the present invention that distinguishes it from a conventional payment services is that this payment service acts as an agent of the Payer and offers the payment to the Payee for their acceptance rather than acting as the agent of the Payee and automatically accepting the payment. This allows the Payee to have a full control over the payment process.

Another feature of the present invention that distinguishes it from a conventional payment services is that it allows the Payee to make partial acceptance of the offered payment or attach conditions to the acceptance process, which would change the legal position of the Payee. In the case where the Payee receives a payment offer, the Payee can respond with what amounts to a ‘counter offer’ to the Payer and if the Payer accepts the modification or alternative, they can agree to the change, and then the payment is processed with the agreed change.

Yet another feature of the present invention that distinguishes it from a conventional payment services is that it allows the Payee to make a counter-proposal for the acceptance of the offered payment or conditional rejection of the payment, to which Payer can agree and continue with the same payment, rather than submitting another payment. Alternatively, Payer can also set certain rules or conditions that would allow automatic acceptance of certain conditions attached by Payee and continue with the same payment, without any resubmission.

These and other beneficial features and advantages of the present invention are disclosed in detail hereinafter with reference to the accompanying drawings and descriptive matter in each embodiment of the invention.

### BRIEF DESCRIPTION OF THE DRAWINGS

FIG. 1 is a block diagram of the principal components of the payment system in accordance with at least one embodiment of the present invention.

FIG. 2 is a flow diagram showing the operation of the payment system and method in accordance with at least one embodiment of the present invention.

FIG. 3 is a flow diagram showing the operation of the payment system and method on the server in accordance with at least one embodiment of the present invention.

### DETAILED DESCRIPTION OF THE INVENTION

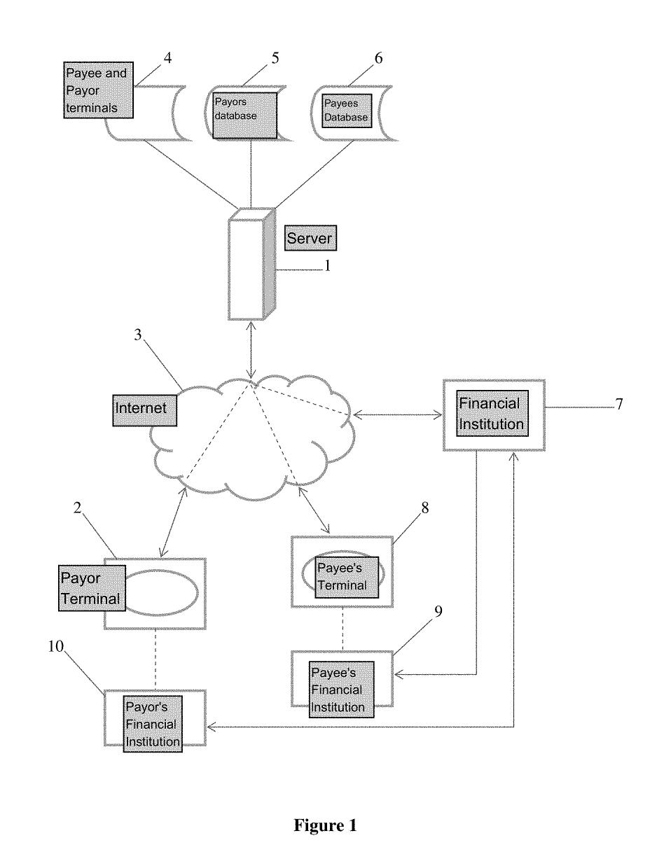

The physical components of one embodiment of the system and method are shown schematically in FIG. 1. The primary software and records database is located at server 1. The system may be configured with multiple servers in different locations, interconnected and sharing databases as necessary. The server 1 comprises at least one computer processor for processing computer instructions that implement the present system and method, a display for displaying the information, and a computer memory for storing the computer instructions. It may also have a database of different Payees and/or Payers that subscribe to the offered services, and the personal user information for each, including userids and passwords provided by the users.

Server 1 also includes an interface for use by Payers who will make payments. Payers communicate with server 1 through their terminals 2 via the Internet 3. The Payer terminal could be a personal computer, a wireless handheld input device, or any device capable of electronic communication with server 1 and Internet connection. In a preferred embodiment, the Payer terminal only needs standard web browser software to communicate with the server. In other embodiment, the Payer terminal can proceed through a local area network.

Server 1 contains database of Payer customers and Payee merchants 4, interface software for Payers 5 and interface software for Payees 6. Server 1 may also contain transaction processing software capable of interconnecting with financial institutions used by Payers and withdrawing funds as authorized by Payers. In the displayed embodiment, software on server 1 communicates via the Internet 3 with a transaction processing server of a financial institution 7. The processing service communicates directly with the institutions 10 holding funds of Payers and effects and tracks the movement of funds into the system and then to the Payee's financial institution 9.

Payee merchants are connected to server 1 via the Internet 3 through Payee terminals 8, which may be browser-enabled personal computers or other mobile and personal devices or servers. The operation of the system is described below.

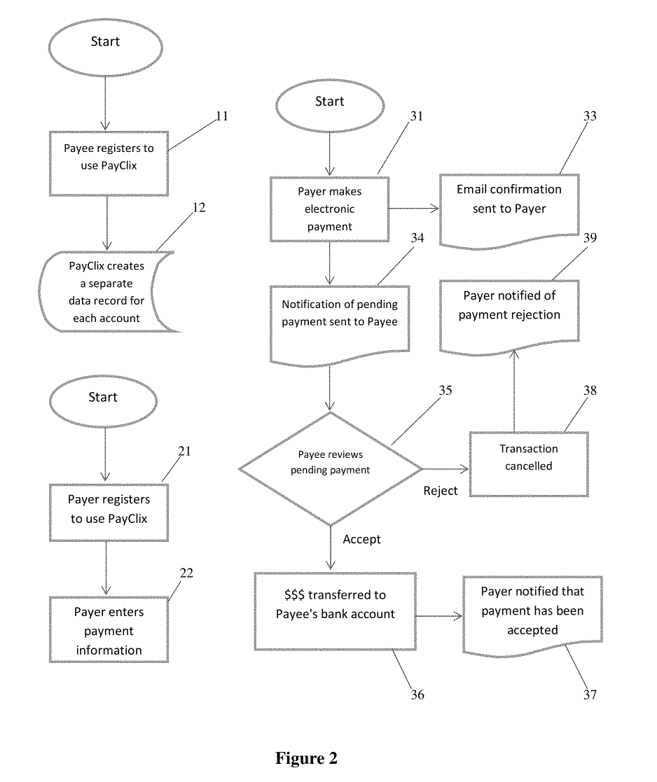

Operation of the system is illustrated with reference to FIG. 2. In this embodiment, a Payer makes a payment to a Payee through a payment processing software system residing on server 1. As noted above, the funds transfers could alternatively be handled by a server at a financial institution.

The Payee registers an account with the Payee and any accounts to be included in the payment processing system 11, and in the course of doing so creates a unique user name with an accompanying password for future system access. Data entry may include contact personnel, email addresses, bank account information, payment acceptance policies, late fees, and other information for each Payee account 12.

A Payer registering with the system 11 creates a unique user name and password. Payer also adds information identifying the account to be credited, the Payee's identity, and the financial institution through which Payer will be making payments 22. Payer may have option of registering for an ‘automatic payment’ option whereby the system will automatically debit their bank account or credit card on a predetermined day each month.

One of the terms of registration that must be agreed to by Payer upon registration, is that the Payer appoints the system operator as his agent for notifying Payee that the Payer wishes to submit a payment and to transmit to the Payee the payment amount if the payment is accepted by the Payee. This allows actual transfer of funds to take place only upon the actual acceptance of the payment by the Payee, with or without additional conditions.

Payer may also be advised that payments will incur a convenience fee, which will be added to the amount that they authorize be debited to their account.

When the Payer decides to use the system, the Payer logs in and completes an electronic form to make an electronic payment using the system software 31. Payment may be made using credit card, debit card or via an electronic check (ACH).

When the Payer approves the payment, the software initiates the transfer of funds via an Internet transaction. Funds remain in the Payer's account until a decision is made by the Payee to accept or reject the proffered payment. If the Payer's financial institution denies an authorization, the Payer is informed, the transaction fails and no transfer of funds occurs. If the Payer pays by credit card, the software may communicate with the credit card processor to reserve or hold available the funds until demanded at a later step in the process.

If the credit card or bank debit transaction is authorized by the Payer's financial institution, the Payer receives an immediate confirmation of payment received 33 via email, conditional upon acceptable of the payment by the Payee and sufficient funds being available in the Payer's account.

The Payee or his designated agent receives an email notice that Payer has proffered a payment 34. The Payee then decides whether or not to accept the proffered payment. This is done by following a link provided in the notification email and signing into the system by supplying the unique user name and password. The Payee is then presented with a web form listing current ‘Pending Payments’ for each account managed. For each pending payment, the Payee selects, by clicking on a ‘radio button’, his decision to Accept or Reject the pending payment. A ‘radio button’ is a common web form data control. It has only an ‘on’ or ‘off’ state and when multiple options are available, e.g., ‘Accept’ or ‘Reject,’ allows only one option to be chosen.

When the choice is made to either ‘Accept’ or ‘Reject’, the software then follows the appropriate logic path as set out below. It is to be expected that there will be a delay in the period between the time a Payer authorizes a payment and the payment is evaluated for acceptance by the Payee. The Payee, when registering to use the system, contractually agrees that the ‘payment date’ will be the date the Payer submits the payment and not the date the Payee accepts the payment. Thus, a payment made at 11:59 PM on the last day for accepting rents before the due date would not be considered to be late even if the Payee did not make a decision to accept the payment until several days later. This reconciles customary industry practice, where a rent payment is not actually ‘made’ until it is accepted by the Payee, with a system in which the Payee does not wish to deal immediately with a payment the instant it is tendered, but will give retroactive credit to properly tendered payments. The software may, for example, contain numerous edits and warning to alert users of unusual conditions, e.g., a pending payment still outstanding four days after it was proffered.

If the payment is accepted, Payer's funds are transferred automatically and electronically into the Payee's account 36. If a credit card amount was reserved, the funds may be transferred from the credit card's sponsoring institution. The Payer is notified that payment was accepted 37. At the same time, a payment processing fee (also termed a convenience fee) agreed to by the Payee is transferred to the operator's bank account.

If the payment is rejected, the transaction is canceled and no funds are transferred to the Payee 38 and the Payee may write a reason for the rejection 39. It is then the Payer's obligation to contact the Payee and work out a non-electronic payment scheme to the obligation or make a new submission with the required payment amount.

Regardless of their decision, the Payee may be given an opportunity to add comments to the decision email before it is sent to the Payer.

The Payee may have access to numerous reports which aid in managing their business. These reports include listings of previously accepted payments, rejected payments and pending payments. Reports may be ordered by the user in various sort sequences with appropriate arithmetic totals and sub-totals. The disclosed invention is not limited to the example given above. Indeed, the claimed methodology can be applied to virtually all other electronic payment systems where a payment is proffered under the terms of an agreement or contract. The software may also include a rules-based decision matrix, the decision parameters of which can be controlled interactively by the recipient, which would automate the acceptable or rejection of payments without manual intervention.

The claimed methods of this invention may substantially reduce the payment processing difficulties faced by companies who receive periodic payments where the Payee can make a payment at an amount lower that is contractually required, the acceptance of which then binds the recipient to certain legal obligations which can be restrictive or undesired.

As discussed above, the present system may be also utilized for a “Conditional Accept” processing. In such a case, the Payee may also have an option to “Accept’ the payment with some conditions that need to be accepted by the Payer. In such case, the system will operate as if it has rejected the payment at step 35, and the Payee will indicated the condition for the Conditional Acceptance in the comment or message 39 to the Payer. The Payer could then either accept the condition and indicate that the authorized payment now complies with the indicated condition, or could reject and cancel 38 the transaction.

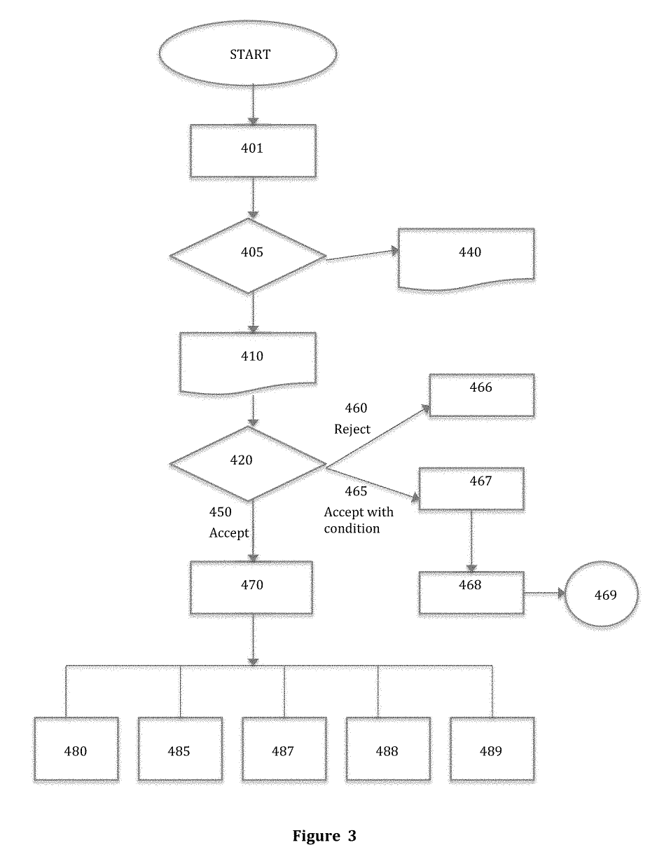

The processing of the method and system of the present invention on the Server is discussed with reference to FIG. 3. A payment indicator is received by the server at 401. If the server determines 405 that a payment request is submitted by anyone other than the merchant Payee, it may send an email alert 410 to the merchant Payee and let the Payee know that the payment is pending. It then requests 420 merchant Payee's acceptance 450 or rejection 460 and awaits a response. If the payment indicator is received from a customer or the support personnel on the server, as for example when processing payment request from a customer over the phone, then the server may send and display 440 a message to Payer that the payment is pending review and either acceptance or rejection by the merchant Payee's pending payment.

If the merchant Payee rejects offered payment 460, or accepts with a specific condition 465 that has to be agreed upon by the Payer, then the sever will request 466 the Payee to enter a reason for the rejection or enter the specific condition 467 for the “Conditional Acceptance,” and then send this information to the Payer 468. Once received, the Payer can review the reason or condition and either generate a new payment request or add an indication that the payment meets the requested condition and send this information back to the server 469.

In addition to the above, the serer may also store and process Payee's Acceptance of the payment by initiating actual funds transfer 470 from the financial institution indicated by the Payer. The server may also allow the Payee to enter and set “AutoAccept” option or conditions 480 under which offered payments are automatically accepted. It may also display payments that are pending acceptance 485, view payment history 487, view invoice details 488 for the processed and pending payments and other possible options 489, such as setting up a secondary contact, administrator or authorized agent. The server may also allow setting different rules and options or conditions for different types of payments and/or different Payers.

In another embodiment of the present invention, the present system and method may be utilized for the debt collection services or any negotiations with the debtor. The present system and method allows debt collectors to automatically process and accept payments from their debtor clients.

By utilizing a rules database or customized software for implementing and processing conditions at 480, the present system may accept a proposal from the debtor to pay off his or her debt by offering a lesser amount than the current owed balance. For example, the debt collector or the creditor that owns the debt can set an acceptable or minimum payment acceptance criteria for a single debtor or groups of similar accounts, and each debtor's proposal is then evaluated according to this criteria.

In the preferred embodiment, this criteria is stored as one or more rules in the rules database, which is accessed by the software processed by a processor on the server 1. If the proposed payment is equal to or greater than the acceptance threshold set by the creditor, the debtor is notified their proposal has been ‘Accepted’ and the offered amount is then processed and deposited directly into the creditor's account in accordance with the system described herein.

A number of other types of conditions may also be preset and evaluated at step 480 in determining whether the debtor's proposal meets the minimum threshold set by the creditor or debt collector. It could determine the duration of repayment term, number of payments, specific payment methods and other terms. If, after the evaluation, the system determines that the offered amount does not meet some preset conditions, but possibly meets others, or is relatively close to the threshold requirements and conditions, it may automatically engage or signal the debt collector to engage in further negotiations with the debtor, and try to narrow any ‘acceptance gap’ using classic ‘offer and acceptance’ strategies or similar known negotiations tactics.

If a negotiated settlement cannot be reached after a specified number of iterations, the debtor's final offer will be emailed to the responsible debt collector for further follow-up or their manual ‘Accept’ or Reject′ decision based on their knowledge of the debtor and any possible mitigating circumstances. The original willingness of the debtor to make an offer to settle would still represent an opportunity to negotiate a settlement.

One important feature of the present invention and system is the use of automated software, processed by a processor, which automatically and instantly evaluates the proposed offers received from the debtor, or counter-proposal, compares it to one or more conditions preset by the creditor or debt collector (or the supervisor), and make an automatic determination whether these conditions are met, partially met, or likely to be met. In determining the likelihood of meeting the required threshold or multiple conditions, the present system and method may utilized historical database or information about other debtors, and may determine the probability of reaching the required threshold in a repeating negotiations, or by making counter-offers.

In order to be able to process a payment proposal from a debtor, the following data may be received and processed: (a) the account number or other unique identifier of the debtor's account; (b) the debtor's full name; (c) the debtor's email address for communicating the result of their proposal and sending a confirmation of the settlement if the debtor's proposal is accepted and funded; and (d) the current amount of the outstanding debt.

A debtor, as an individual, or as a part of a much larger group, can be invited to make a proposal by either sending a link to the server page in an email, or by providing the link in a mailed statement. Debtors without an email address on file may be requested to supply their address when they first register to use the server for debt settlement negotiations.

The debt collection management software can generate a report in Excel format with at least the account number or another unique identified for the debtor's account, the debtor's name and the current balance. Additionally, it may optionally include debtor's email address. This data file or information can then be uploaded to the server on a regular basis with a single click.

The debt collector or creditor may define their minimum acceptance criteria, such as for example (a) the percentage of the outstanding balance that represents the minimum acceptable amount paid in a single payment; (b) the incremental percentage premium for each payment in a series of payments. The incremental premium is meant to recognize the time value of money and the possible risk in the debtor defaulting on their agreed payoff plan. The maximum number of payments or the duration of the repayment schedule might be additional parameters.

Some other factors may also be included in the automated acceptance processing system according to at least one embodiment of the present system. These additional factors could be the annual income, the number of months working for the same employer, the amount of any other outstanding debt, such as, for example, the car loan or mortgage.

In one example, the acceptance criteria percentages might be as follows: (a) a 50% for a single payment; OR (b) an additional 2% for each payment in a series of payments, in addition to the base percentage; AND (c) a minimum of 6 months employment with the same employer. Applying these factors and percentages to the above example, a proposal repayment would be automatically “accepted” by the condition processing evaluation step when the following conditions are met:

(1) A single payment of $750.00 (50% of balance due)

### OR

(2) 3 payments of $280.00 for a total of $840.00 (50% of balance due+6%=56%),

### AND

(3) 8 months continuous employment with their current employer.

In the above example, the debtor making the payment will be charged a processing service fee to cover the bank charges for using a credit card to make the payment(s). The total amount of this service fee will be fully disclosed to the person making the payment prior to them submitting the payment for funding and deposit into the debt collector's bank account. The debt collector would also have an option to pay the transaction processing fee for the service provided by the operator of the present automated Acceptance/Rejection server and system.

The above embodiments and illustrative descriptions of the application of the principles of the present invention are intended to enable a person skilled in the art to make or use the disclosed invention. They are not intended to be either exclusive, exhaustive or limiting on the scope of the invention described and claimed herein. Other variations or modification could be used and applied by a person skilled in the art without deviating from the scope and spirit of the present invention. Such modifications and alternatives arrangements are not intended invention to be outside the scope of the present invention and are intended to be covered by it. The invention title and abstract are not intended to limit the claimed invention or cover multiple embodiment and all various features of the claimed invention.

1. A method for transferring electronic payments comprising the steps of:
(a) receiving into an electronic payment system a plurality of requests for electronic payments from at least one Payer to a designated Payee;
(b) querying the Payee whether to accept or reject each of said payments;
(c) sending funds to an account designated by the Payee only after Payee accepts at least one of said plurality of electronic requests for electronic payment from the at least one Payee;
(d) cancelling the transaction and not finalizing actual payment transfer if Payee rejects the electronic request for payment from at least one Payee.

2. The method of claim 1 further comprising sending a notification and payment details to at least one Payer when the request for payment from said at least one Payer is rejected by Payee.

3. The method of claim 1 further comprising sending a notification to the Payee when a payment is received from said at least one Payer.

4. The method of claim 1 further comprising sending a notification to at least one Payer when at least one of said electronic payment requests from the Payer is accepted by the Payee.

5. The method of claim 1 wherein said payment is of the type selected from the group consisting of credit card, debit card, or an electronic check.

6. The method of claim 1 wherein said at least one Payer is charged a convenience fee for using said electronic payment system, payable to the operators of said electronic payment system.

7. The method of claim 1 wherein said Payee is charged a processing fee for using said electronic payment system, payable to the operators of said electronic payment system.

8. The method of claim 1 further comprising sending notification to the Payee when a payment is received from the at least one Payer, and sending notification and details to the Payer when the corresponding payment request is accepted or rejected by the Payee.

9. The method of claim 1 further comprising:
(e) receiving additional conditions from the Payee for the at least one payment from the Payer;
(f) sending the additional condition for the review by the Payer;
(g) receiving a response to the additional conditions from the Payer, an
(h) finalizing the funds transfer if the additional conditions are accepted by the Payer. notification to the Payee when a payment is received from the at least one Payer.

10. The method of claim 9 further comprising:
(i) providing a list of pending payments for the Payee;
(j) providing a list of prior accepted payments by the Payee;
(k) receiving and processing at least one instruction from the Payee concerning the list of pending payments; and
(l) transferring funds from the Payer to the Payee for at least one payment on the said list.

11. An automated system for transferring electronic payments comprising:
at least one server having a display, memory and a processor; said processor disposed in communication with said memory to issue a plurality of processing instructions stored in the memory, wherein the processor issues instructions to:
(a) receiving by a server a plurality of requests for electronic payments from at least one Payer to a designated Payee;
(b) querying the Payee whether to accept or reject each of said payments;
(c) sending funds to an account designated by the Payee only after Payee accepts at least one of said plurality of electronic requests for electronic payment from the at least one Payee; and
(d) cancelling the transaction and not finalizing actual payment transfer if Payee rejects the electronic request for payment from at least one Payee.

12. The system of claim 11, wherein said server further executes computer instructions for sending a notification and payment details to at least one Payer when the request for payment from said at least one Payer is rejected by Payee.

13. The system of claim 11, wherein said server further executes computer instructions for sending a notification to the Payee when a payment is received from said at least one Payer.

14. The system of claim 11, wherein said server further executes computer instructions for sending a notification to at least one Payer when at least one of said electronic payment requests from the Payer is accepted by the Payee.

15. The system of claim 11, wherein said payment is of the type selected from the group consisting of credit card, debit card, or an electronic check.

16. The system of claim 11, wherein said server further executes computer instructions to charge said at least one Payer a convenience fee for using said electronic payment system, payable to the operators of said electronic payment system.

17. The system of claim 11, wherein said server further executes computer instructions to charge said Payee a processing fee for using said electronic payment system, payable to the operators of said electronic payment system.

18. The system of claim 11, wherein said server further executes computer instructions for sending notification to the Payee when a payment is received from the at least one Payer, and sending notification and details to the Payer when the corresponding payment request is accepted or rejected by the Payee.

19. The system of claim 11, wherein said server further executes computer instructions for
(e) receiving additional conditions from the Payee for the at least one payment from the Payer;
(f) sending the additional condition for the review by the Payer;
(g) receiving a response to the additional conditions from the Payer;
(h) finalizing the funds transfer if the additional conditions are accepted by the Payer. notification to the Payee when a payment is received from the at least one Payer;
(i) providing a list of pending payments for the Payee;
(j) providing a list of prior accepted payments by the Payee;
(k) receiving and processing at least one instruction from the Payee concerning the list of pending payments; and
(l) transferring funds from the Payer to the Payee for at least one payment on the said list.

20. A method for accepting electronic payments in a debt collecting system, comprising the steps of:
(a) receiving into an electronic payment system at least one request for electronic payments from at least one debtor to a designated creditor;
(b) automatically extracting from a database of rules at least one rule containing the acceptance conditions authorized by the creditor;
(c) automatically evaluating at least one extracted rule and determine whether the required conditions are met by the request from the debtor;
(d) sending funds to an account designated by the creditor only after all said rules and conditions are satisfied based on the present values previously provided by the creditor and stored in the database; and
(e) rejecting the electronic request for payment from at least one debtor if at least one of said rules and conditions is not satisfied, and sending an automated counter-offer to the debtor.
